(19) United States
(12) Patent Application Publication
(10) Pub. No.: US 2003/0187737 A1
(43) Pub. Date: Oct. 2, 2003

(54) System, method, and program for banner advertising

(75) Inventor: Thoshihiro Naito, Tokyo (JP)

Correspondence Address: McGinn & Gibb, PLLC, Suite 200, 8321 Old Courthouse Road, Vienna, VA, 22182-3817, US

(73) Assignee: NEC Corporation, Tokyo (JP)

(21) Appl. No.: 10/166,628

(22) Filed: Jun. 12, 2002

(30) Foreign Application Priority Data
Jun. 13, 2001 (JP) 178664/2001

(51) Int. Cl. G06F 17/60

(52) U.S. Cl. 705/14

(57) ABSTRACT

A banner advertising system, a banner advertising method, and a program thereof are provided to achieve higher advertising effects by getting users to browse advertisements on a Web site numerous times. Having received an acquisition request from a user terminal via a Web server, a random number generator generates a random number. A rank identifying device identifies a rank on the basis of the generated random number. The Web server selects a piece of information from plural kinds of information stored therein on the basis of the identified rank, and transmits the selected information to the user terminal.

### BACKGROUND OF THE INVENTION

The present invention relates to a system, a method, and a program for banner advertising, and in particular, to a banner advertising system, a banner advertising method and a program thereof for randomly selecting a piece of information from a plurality of information and sending the information to a user terminal when an acquisition request for information is sent from the user terminal.

### Description of the Related Art

On the Internet, there is widely employed a style of advertising wherein banner advertisements are put on Web pages. However, it is often the case that almost every user who visits the Web pages does not click the banner advertisements, and accordingly, the desired effects of the banner advertisements have not been achieved.

To resolve the problem, a method for delivering information on the Internet and a program for implementing the same are disclosed in Japanese Patent Application Laid-Open No. 2000-194636 (hereinafter referred to as a prior example 1). In the prior example 1, when a user clicks a banner advertisement to view its content, a server provides a predetermined service and information to the user.

Moreover, a system for promoting participation in prize competitions is disclosed in Japanese Patent Application Laid-Open No. 2000-293591 (hereinafter referred to as a prior example 2). In the prior example 2, when an applicant for a prize answers questions prepared by an intermediary server and the ratio of right answers to the questions exceeds a predetermined standard value, the applicant can participate in the prize competition prepared by a prize provider. An information providing server managed by the prize provider prepares hints to answer the questions correctly. Consequently, the number of users (applicants for the prize) who accesses the information providing server increases to get the hints.

Furthermore, an advertising system employing a question format is disclosed in Japanese Patent Application Laid-Open No. 2001-84302 (hereinafter referred to as a prior example 3). In the prior example 3, there are provided questions that can be answered correctly if visiting a Web site managed by an advertiser to get hints as to the questions. Accordingly, users can answer the questions according to the hints in the Web site, thus enabling the users to participate in a prize competition.

However in the prior example 1, a banner advertisement generally has one content available for browsing with one click, and users are unlikely to click the banner advertisement more than once. To resolve the problem, there is a need to periodically change the content of the banner advertisement. However, this leads to complications in processing. Moreover, unless a content available for browsing arouses users' interests, the users are unlikely to click the banner advertisement including the content.

Furthermore in the prior examples 2 and 3, users have to answer the questions. Therefore, it is difficult to get users to click a banner advertisement again and again.

### SUMMARY OF THE INVENTION

It is therefore an object of the present invention to provide a banner advertising system, a banner advertising method and a program thereof for achieving higher advertising effects by getting users to browse advertisements on Web pages repeatedly.

According to a first aspect of the present invention, for achieving the objects mentioned above, there is provided a banner advertising system comprising:

a Web server for storing plural kinds of information including advertisements; and

a user terminal connected to the Web server through a predetermined network; wherein

the Web server transmits information randomly extracted from the plural kinds of information including advertisements to the user terminal when receiving an acquisition request for information from the user terminal.

According to a second aspect of the present invention, there is provided a banner advertising system comprising;

a user terminal connected to a predetermined network for transmitting an acquisition request for information through the predetermined network;

a Web server connected to the predetermined network for receiving the acquisition request for information from the user terminal through the predetermined network;

a random number generator connected to the Web server for generating a random number in response to the acquisition request for information received via the Web server; and

a rank identifying device connected to the Web server and the random number generator for converting the random number generated by the random number generator to predetermined data; wherein

the Web server extracts any one of plural kinds of information stored in the Web server on the basis of the predetermined data converted by the rank identifying device, and transmits the extracted information to the user terminal.

According to a third aspect of the present invention, there is provided a banner advertising system comprising:

a user terminal connected to a predetermined network for transmitting an acquisition request for information provided by an advertiser through the predetermined network;

a Web server connected to the predetermined network for transmitting advertising information including at least an advertisement to the user terminal and displaying the advertising information on the user terminal when receiving the acquisition request for the provided information from the user terminal through the predetermined network;

a random number generator connected to the Web server for generating a random number in response to the acquisition request for the provided information received via the Web server; and

a rank identifying device connected to the Web server and the random number generator for converting the random number generated by the random number generator to predetermined data; wherein

the Web server extracts any one of the provided information of plural kinds stored in the Web server on the basis of the predetermined data converted by the rank identifying device, and transmit the extracted provided information to the user terminal.

According to a fourth aspect of the present invention, in the third aspect, the Web server measures time since the Web server transmitted the advertising information to the user terminal, and transmits the extracted provided information to the user terminal when the measured time exceeds a predetermined time.

According to a fifth aspect of the present invention, there is provided a banner advertising system comprising:

a Web server connected to a user terminal through a predetermined network for receiving an acquisition request for information from the user terminal;

a random number generator connected to the Web server for generating a random number in response to the acquisition request for information received via the Web server; and

a rank identifying device connected to the Web server and the random number generator for converting the random number generated by the random number generator to predetermined data; wherein

the Web server extracts any one of information of plural kinds stored in the Web server on the basis of the predetermined data converted by the rank identifying device, and transmits the extracted information to the user terminal.

According to a sixth aspect of the present invention, there is provided a banner advertising method using a Web server storing plural kinds of information including advertisements and a user terminal connected to the Web server through a predetermined network, wherein

the Web server transmits information randomly extracted from the plural kinds of information including advertisements to the user terminal when receiving an acquisition request for information from the user terminal.

According to a seventh aspect of the present invention, there is provided a banner advertising method, when a Web server receives an acquisition request for information from a user terminal through a predetermined network, comprising the steps of:

generating a random number;

converting the generated random number to predetermined data;

extracting any one of information of plural kinds on the basis of the converted predetermined data; and

transmitting the extracted information to the user terminal.

According to an eighth aspect of the present invention, there is provided a banner advertising method, when a Web server receives an acquisition request for information provided by an advertiser from a user terminal through a predetermined network, comprising the steps of:

transmitting advertising information including at least an advertisement to the user terminal;

displaying the advertising information on the user terminal;

generating a random number;

converting the generated random number to predetermined data;

extracting any one of the provided information of plural kinds on the basis of the converted predetermined data; and

transmitting the extracted provided information to the user terminal.

According to a ninth aspect of the present invention, in the eighth aspect, the Web server measures time since the Web server transmitted the advertising information to the user terminal, and transmits the extracted provided information to the user terminal when the measured time exceeds a predetermined time.

According to a tenth aspect of the present invention, there is provided a banner advertising program for executing processes by a Web server storing plural kinds of information including advertisements, and a user terminal connected to the Web server through a predetermined network, wherein

the Web server transmits information randomly extracted from the plural kinds of information including advertisements to the user terminal when receiving an acquisition request for information from the user terminal.

According to an eleventh aspect of the present invention, there is provided a banner advertising program for executing:

a process, by a Web server, of receiving an acquisition request for information from a user terminal connected to the Web server through a predetermined network;

a process, by a random number generator connected to the Web server, of generating a random number in response to the acquisition request for information received via the Web server;

a process, by a rank identifying device connected to the Web server and the random number generator, of converting the random number generated by the random number generator to predetermined data; and

a process, by the Web server, of extracting any one of information of plural kinds stored in the Web server on the basis of the predetermined data converted by the rank identifying device and transmitting the extracted information to the user terminal.

According to a twelfth aspect of the present invention, there is provided a banner advertising program for executing:

a process, by a Web server, of transmitting advertising information including at least an advertisement to a user terminal and displaying the advertising information on the user terminal when receiving an acquisition request for information provided by an advertiser from the user terminal connected through a predetermined network;

a process, by a random umber generator connected to the Web server, of generating a random number in response to the acquisition request for the provided information received via the Web server;

a process, by a rank identifying device connected to the Web server and the random number generator, of converting the random number generated by the random number generator to predetermined data; and

a process, by the Web server, of extracting any one of the provided information of plural kinds stored in the Web server on the basis of the predetermined data converted by the rank identifying device, and transmitting the extracted provided information to the user terminal.

According to a thirteenth aspect of the present invention, in the twelfth aspect, the banner advertising program executes a process, by the Web server, of measuring time since Web server transmitted the advertising information to the user terminal, and transmitting the extracted provided information to the user terminal when the measured time exceeds a predetermined time.

### BRIEF DESCRIPTION OF THE DRAWINGS

The objects and features of the present invention will become more apparent from the consideration of the following detailed description taken in conjunction with the accompanying drawings in which:

FIG. 1 is a diagram showing a configuration of a banner advertising system according to a first embodiment of the present invention;

FIG. 2A is a table indicating a correspondence between a random number and a rank used in the first embodiment of the present invention;

FIG. 2B is a table indicating a correspondence between a rank and an information content used in the first embodiment of the present invention;

FIG. 2C is a table indicating a correspondence among a random number, a rank, and an information content used in the first embodiment of the present invention;

FIG. 3 is a diagram showing transition of display screens of prize Web pages used in the banner advertising system according to the first embodiment of the present invention;

FIG. 4 is a diagram showing a screen configuration of a category selection screen 40 used in the banner advertising system according to the first embodiment of the present invention;

FIG. 5 is a diagram showing a screen configuration of a banner advertisement selection screen 41 used in the banner advertising system according to the first embodiment of the present invention;

FIG. 6 is a diagram showing a screen configuration of a content list display screen 42 used in the banner advertising system according to the first embodiment of the present invention;

FIG. 7 is a diagram showing a screen configuration of a content lot result screen 43 used in the banner advertising system according to the first embodiment of the present invention;

FIG. 8 is a diagram showing a screen configuration of a download screen 44 used in the banner advertising system according to the first embodiment of the present invention;

FIG. 9 is a flowchart showing operation of the banner advertising system according to the first embodiment of the present invention;

FIG. 10 is a diagram showing transition of display screens of prize Web pages used in the banner advertising system according to a second embodiment of the present invention;

FIG. 11 is a diagram showing a screen configuration of a banner advertisement selection screen 51 used in the banner advertising system according to the second embodiment of the present invention;

FIG. 12 is a diagram showing a screen configuration of a gift list display screen 52 used in the banner advertising system according to the second embodiment of the present invention;

FIG. 13 is a diagram showing a screen configuration of an advertisement display screen 53 used in the banner advertising system according to the second embodiment of the present invention;

FIG. 14 is a diagram showing a screen configuration of a gift lot result screen 54 used in the banner advertising system according to the second embodiment of the present invention; and

FIG. 15 is a flowchart showing operation of the banner advertising system according to the second embodiment of the present invention.

### DESCRIPTION OF THE PREFERRED EMBODIMENTS

Referring now to the drawings, embodiments of the present invention will be explained in detail.

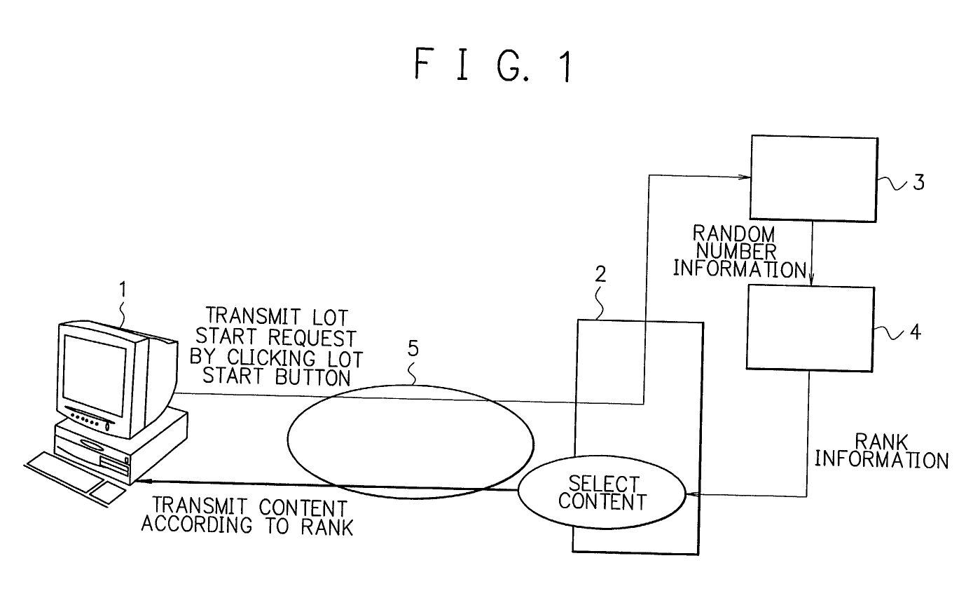

FIG. 1 is a diagram showing a configuration of a banner advertising system according to a first embodiment of the present invention. In the following, an explanation will be given of the banner advertising system according to the first embodiment.

The banner advertising system according to the first embodiment comprises at least a user terminal 1, a Web server 2, a random number generator 3, a rank identifying device 4, and Internet 5.

The user terminal 1 is connected to the Web server 2 via the Internet 5. The user terminal 1 includes a Web browser (not shown) by which various Web pages on the Internet 5 can be displayed on the screen of the user terminal 1. Incidentally, the user terminal 1 may be a personal computer (PC), a personal digital assistance, or the like. Moreover, a plurality of user terminals may be arbitrarily connected to the Internet 5.

The Web server 2 stores Web pages (hereinafter referred to as prize Web pages) for providing information contents in response to a request from the user terminal 1. A user visits a prize Web site where the prize Web pages are located using the user terminal 1 to browse the contents of the prize Web pages. Subsequently, the user clicks a lot start button set on the prize Web page using the user terminal 1. When the lot start button is clicked, a lot start request (acquisition request for information) is sent from the user terminal 1 to the random number generator 3 via the Web server 2.

The Web server 2 further includes a plurality of information contents of various kinds provided by advertisers. Users are interested in the information contents, and accordingly, they hope to acquire the information contents. The information contents in themselves having advertising effects are sent to winners of lots as gifts. When a lot result screen and a download screen of the Web pages are displayed on the screen of the user terminal 1, predetermined advertising information (at least one advertising message) is displayed on the screen. Thereby, the advertiser can expect higher advertising effects. Incidentally, the information contents may be character information, audio information (including voice, sound, and/or music information), a static image, a moving image, and/or the like.

Furthermore, a “rank” serving as information for identifying an information content is added to the respective information contents of various kinds stored in the Web server 2.

The random number generator 3 generates a random number when receiving the lot start request from the user terminal 1 via the Web server 2. The rank identifying device 4 identifies a rank, which is information represented by a character(s), a figure(s), a symbol(s), or the like, corresponding to each of the information contents on the basis of the random number generated by the random number generator 3. The Web server 2 selects a predetermined information content from the plural information contents of various kinds stored in the Web server 2 on the basis of the information of the rank (hereinafter referred to as rank information) identified by the rank identifying device 4, and sends the selected information content to the user terminal 1. Incidentally, the Web server 2 may select “nothing” regarding the user as drawing a losing ticket.

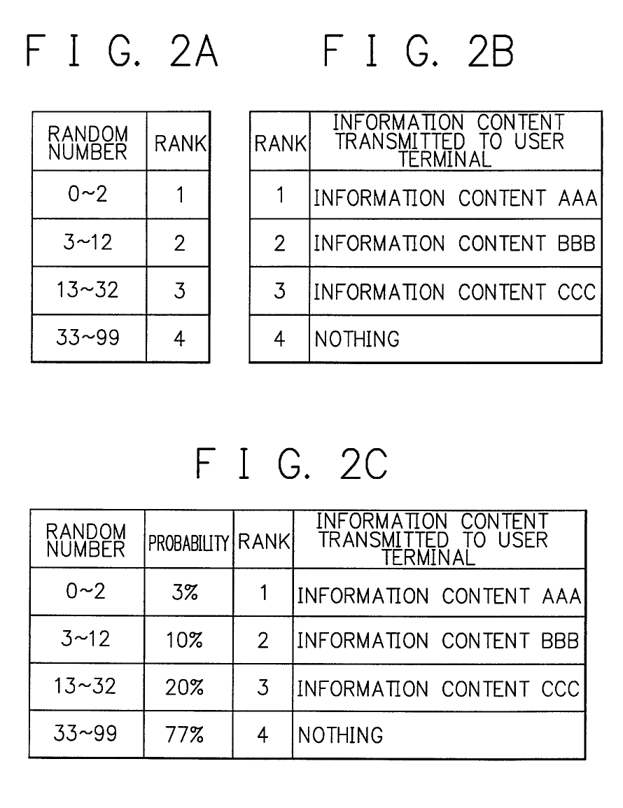

FIG. 2A is a table indicating a correspondence between a random number and a rank used in the first embodiment of the present invention. FIG. 2B is a table indicating a correspondence between a rank and an information content used in the first embodiment of the present invention. FIG. 2C is a table indicating a correspondence among a random number, a rank, and an information content used in the first embodiment of the present invention. In the following, referring to the FIGS. 2A, 2B and 2C, an explanation will be given of the relationship among a random number, a rank, and an information content in the first embodiment.

In this embodiment, it is assumed that the random number generator 3 generates 100 random numbers from 0 to 99 with the same probability for simplicity. Further, it is assumed that an advertiser provides prize Web pages with three information contents AAA, BBB and CCC.

In FIG. 2A, random numbers generated by the random number generator 3 and the ranks corresponding to the numbers are shown. The data in the table indicating the correspondence between each random number and rank (hereinafter referred to as random number—rank corresponding data) in FIG. 2A is stored in the rank identifying device 4. The random number—rank corresponding data is set and changed according to the advertiser's requests. The rank identifying device 4 identifies a rank on the basis of the random number generated by the random number generator 3 and the random number—rank corresponding data. Namely, the rank identifying device 4 converts the random number to a predetermined value (rank) on the basis of the random number—rank corresponding data.

In FIG. 2B, ranks identified by the rank identifying device 4 and the information contents corresponding to the ranks are shown. The data in the table indicating the correspondence between each rank and information content (hereinafter referred to as rank—information content corresponding data) in FIG. 2B is stored in the Web server 2. The rank—information content corresponding data is set and changed according to information contents provided by the advertiser and the advertiser's requests. The Web server 2 selects a predetermined information content from the plural information contents of various kinds stored therein on the basis of the rank identified by the rank identifying device 4 and the rank—information content corresponding data, and sends the selected information content to the user terminal 1.

FIG. 2C shows an expediential table wherein the tables shown in FIGS. 2A and 2B are put together for simple explanation. The table in FIG. 2C further includes information of “probability” of each rank selection. For example, when any one of the random numbers 0 through 2 (three random numbers) is generated, the information content AAA corresponding to the rank “1” is selected by the Web server 2. The possible random numbers are 100 numbers from 0 to 99 altogether, and thereby, the probability that the information content AAA will be selected is 3% (3÷100×100=3(%)). In the same way, the probability that the information content BBB will be selected is 10%, the probability that the information content CCC will be selected is 20%, and the probability that none of the information contents AAA through CCC will be selected is 77%.

As described above, by establishing such variation to the probability, it becomes possible to prompt users to participate in the prize competition many times until they win desired information contents, thus enabling more accesses to information contents. For example, if an information content expected to be deluged with acquisition requests from users is selected with lower probability compared to the other information contents, the number of accesses to information contents can be increased to acquire the popular information content. Accordingly, it is expected that the advertising effects will be increased.

For example, it is assumed that the random number generator 3 generates a random number “11” when receiving a lot start request. Subsequently, the rank identifying device 4 identifies the rank on the basis of the random number information “11” received from the random number generator 3 and the random number—rank corresponding data. In FIG. 2A, the random number “11” corresponds to the rank “2”. Thereby, the rank identifying device 4 identifies the rank as “2”, and sends the rank information “2” to the Web server 2.

The Web server 2 selects an information content on the basis of the received rank information “2” and the rank—information content corresponding data, and sends the selected information content to the user terminal 1. In FIG. 2B, the rank “2” corresponds to the information content BBB. The Web server 2 extracts the information content BBB from the plural information contents of various kinds stored in the Web server 2, and sends the information content BBB to the user terminal 1.

Incidentally, the random numbers and the ranks are not limited to the above values from 0 to 99 and from 1 to 4, respectively. Moreover, the ranks 1, 2, 3, . . . , may be set to the respective information contents in the order of lower probabilities of selection as shown in FIG. 2C, or the ranks may be set on the basis of another setting standard. Further, the information contents provided by the advertiser can be changed. Furthermore, the correspondence among the random numbers, the ranks, and the information contents can be set arbitrarily, and thereby, a table other than the tables shown in FIGS. 2A through 2C may be employed.

Moreover, the random number generator 3 and the rank identifying device 4 may be set in the Web server 2, or may be connected to the Web server 2 via a predetermined network such as the Internet 5, or the like.

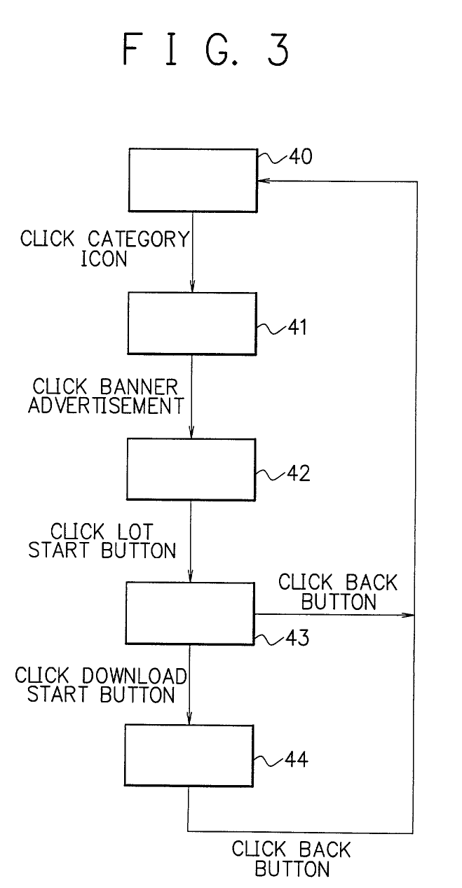

In the following, an explanation will be given of operation of the first embodiment of the present invention. FIG. 3 is a diagram showing transition of display screens of prize Web pages used in the banner advertising system according to the first embodiment of the present invention. In this embodiment, at least a category selection screen 40, a banner advertisement selection screen 41, a content list display screen 42, a content lot result screen 43, and a download screen 44 are displayed on the screen of the user terminal 1 as the prize Web pages.

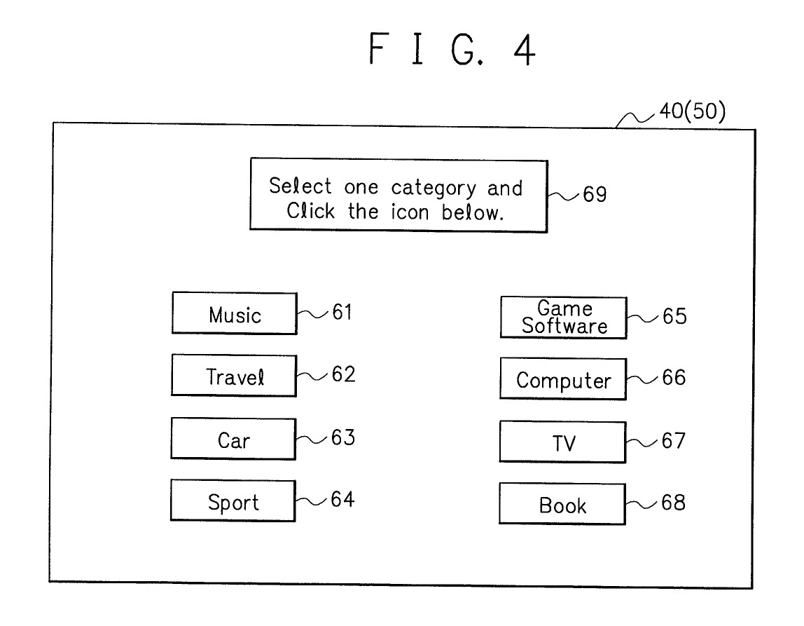

FIG. 4 is a diagram showing a screen configuration of the category selection screen 40 used in the banner advertising system according to the first embodiment of the present invention. The category selection screen 40 comprises at least category icons 61 through 68, and a category selection message 69.

Names of various categories such as “Music”, “Travel”, “Car”, “Sport”, “Game Software”, “Computer”, “TV”, “Book” are displayed in the respective icons 61 through 68. A user selects and clicks any one of the category icons 61 through 68 using the user terminal 1 according to the instruction “Select one category and click the icon below.” displayed in the category selection message 69. When the selected category icon is clicked, the display screen of the user terminal 1 changes to the banner advertisement selection screen 41 corresponding to the clicked category icon.

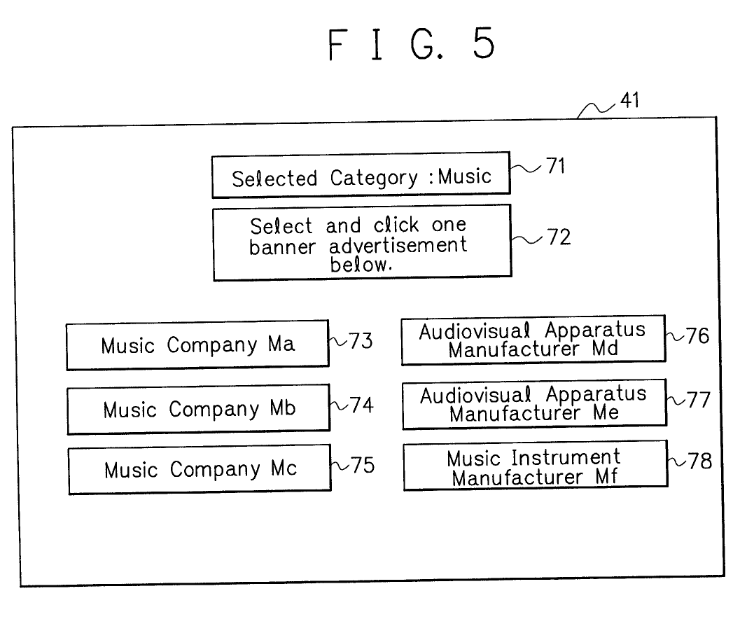

FIG. 5 is a diagram showing a screen configuration of the banner advertisement selection screen 41 used in the banner advertising system according to the first embodiment of the present invention. The banner advertisement selection screen 41 comprises at least a selected category display 71, a banner advertisement selection message 72, and banner advertisements 73 through 78. Incidentally, FIG. 5 shows an example of the banner advertisement selection screen 41 when the category icon 61 “Music” is selected in the category selection screen 40.

The name of the category “Music” selected in the category selection screen 40 is displayed in the selected category display 71. Names of advertisers relative to the category “Music” such as “Music Company Ma”, “Music Company Mb”, “Music Company Mc”, “Audiovisual Apparatus Manufacturer Md”, “Audiovisual Apparatus Manufacturer Me”, and “Music Instrument Manufacturer Mf” are displayed in the respective banner advertisements 73 through 78. The user selects and clicks any one of the banner advertisements 73 through 78 using the user terminal 1 according to the instruction “Select and click one banner advertisement below.” displayed as the banner advertisement selection message 72. When the selected banner advertisement is clicked, the display screen of the user terminal 1 changes to the content list display screen 42 relevant to the advertiser of the clicked banner advertisement.

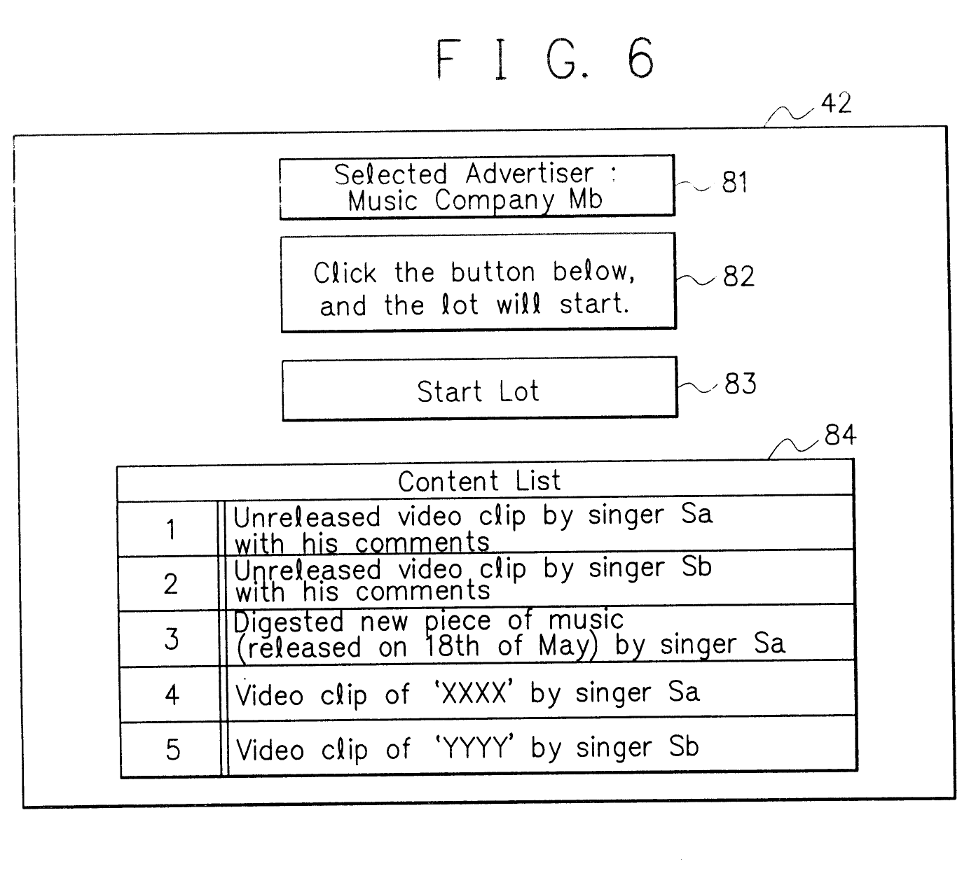

FIG. 6 is a diagram showing a display configuration of the content list display screen 42 used in the banner advertising system according to the first embodiment of the present invention. The content list display screen 42 comprises at least a selected advertiser display 81, a lot start message 82, a lot start button 83, and a content list 84. Incidentally, FIG. 6 shows an example of the content list display screen 42 when the banner advertisement 74 “Music Company Mb” is selected in the banner advertisement selection screen 41.

The name of the advertiser “Music Company Mb” of the banner advertisement selected in the banner advertisement selection screen 41 is displayed in the selected advertiser display 81. There is displayed in the content list 84 available information contents provided by the advertiser such as “1: Unreleased video clip by singer Sa with his comments”, “2: Unreleased video clip by singer Sb with his comments”, “3: Digested new piece of music (released on 18th of May) by singer Sa”, “4: Video clip of ‘XXXX’ by singer Sa”, and “5: Video clip of “YYYY” by singer Sb”. The user clicks the lot start button 83 using the user terminal 1 according to the instruction “Click the button below, and the lot will start.” displayed as the lot start message 82. When the lot star button 83 is clicked, the lot starts, and the display screen of the user terminal 1 changes to the content lot result screen 43.

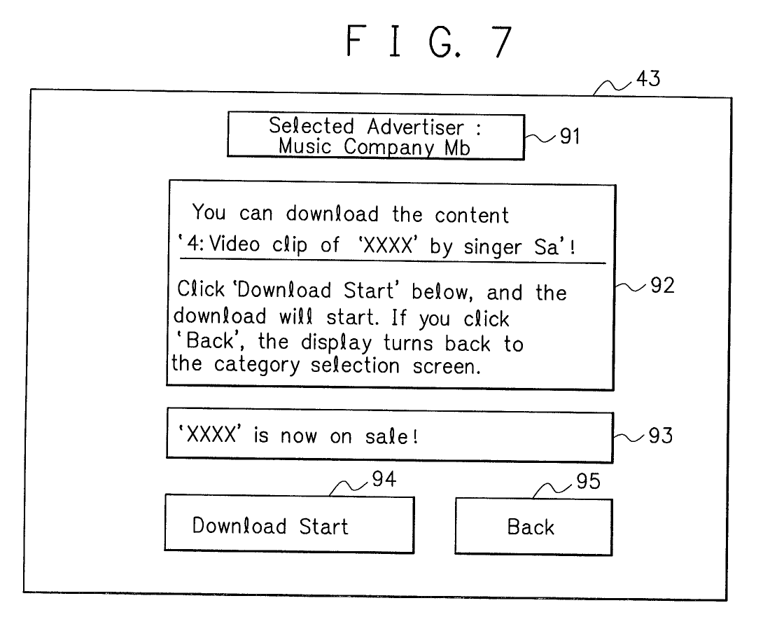

FIG. 7 is a diagram showing a screen configuration of the content lot result screen 43 used in the banner advertising system according to the first embodiment of the present invention. The content lot result screen 43 comprises at least a selected advertiser display 91, a lot result message 92, an advertising message 93, a download start button 94, and a back button 95. Incidentally, FIG. 7 shows an example of the content lot result screen 43 when the information content “4: Video clip of ‘XXXX’ by singer Sa” is selected from the plural information contents as a result of the lot.

The name of the advertiser “Music Company Mb” of the banner advertisement selected in the banner advertisement selection screen 41 is displayed in the selected advertiser display 91. There is displayed as the lot result message 92 a message “You can download the content ‘4: Video clip of ‘XXXX’ by singer Sa’! Click ‘Download Start’ below, and the download will start. If you clicks ‘Back’, the display turns back to the category selection screen.”. The user clicks either the download start button 94 or the back button 95 using the user terminal 1 according to the instruction displayed in the lot result message 92. When the download start button 94 is selected, the display screen of the user terminal 1 changes to the download screen 44. On the other hand, when the back button 95 is selected, the display screen of the user terminal 1 changes to the category selection screen 40 again. Further, a message “‘XXXX’ is now on sale!” is displayed as the advertising message 93. The message displayed in the advertising message 93 may or may not be related to the selected information content.

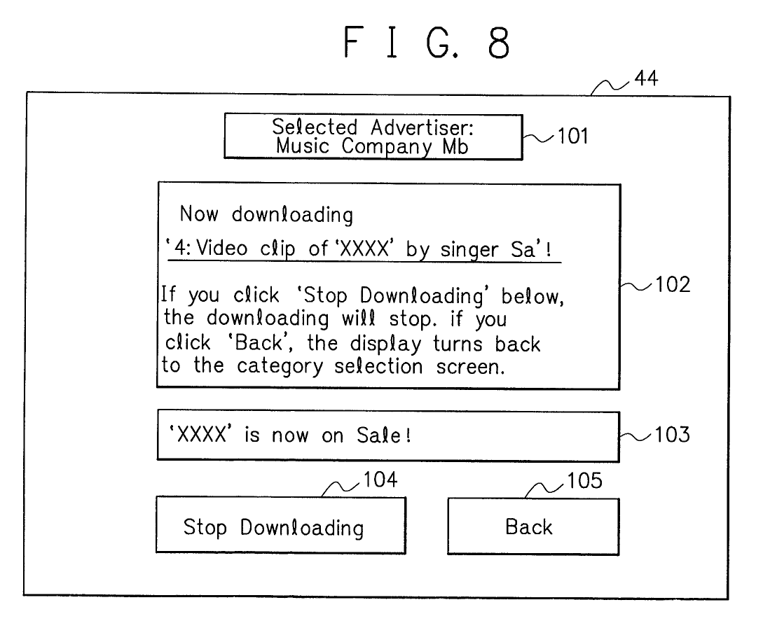

FIG. 8 is a diagram showing a screen configuration of the download screen 44 used in the banner advertising system according to the first embodiment of the present invention. The download screen 44 comprises at least a selected advertiser display 101, a downloading message 102, an advertising message 103, a downloading stop button 104, and a back button 105. Incidentally, FIG. 8 shows an example of the download screen 44 when the download start button 94 is selected in the content lot result screen 43 in FIG. 7.

The advertiser “Music Company Mb” of the banner advertisement selected in the banner advertisement selection screen 41 is displayed in the selected advertiser display 101. There is displayed as the downloading message 102 a message “Now downloading ‘4: Video clip of ‘XXXX’ by singer Sa’. If you click ‘Stop Downloading’ below, the downloading will stop. If you click ‘Back’, the display turns back to the category selection screen.”. The user clicks either the downloading stop button 104 or the back button 105 using the user terminal 1 according to the instruction displayed in the downloading message 102. When the downloading stop button 104 is selected, the downloading of the selected information content is stopped. After the download has been finished or stopped, when the back button 105 is clicked, the display screen of the user terminal 1 returns to the category selection screen 40 again. Further, a message “‘XXXX’ is now on sale!” is displayed as the advertising message 103. The message displayed as the advertising message 103 may or may not be related to the selected information content. Moreover, the message displayed in the advertising message 103 in the download screen 44 may or may not be the same as that displayed in the advertising message 93 in the content lot result screen 43.

Incidentally, while in this embodiment the explanation has been given of a case where the plural advertisers were employed, a single advertiser can be employed. In this case, the category selection screen 40 and the banner advertisement selection screen 41 may not be displayed on the screen of the user terminal 1. Moreover in this case, the Web server 2 may display the content list display screen 42 on the screen of the user terminal 1 after having confirmed an access from the user terminal 1, or may display another kind of screen thereon.

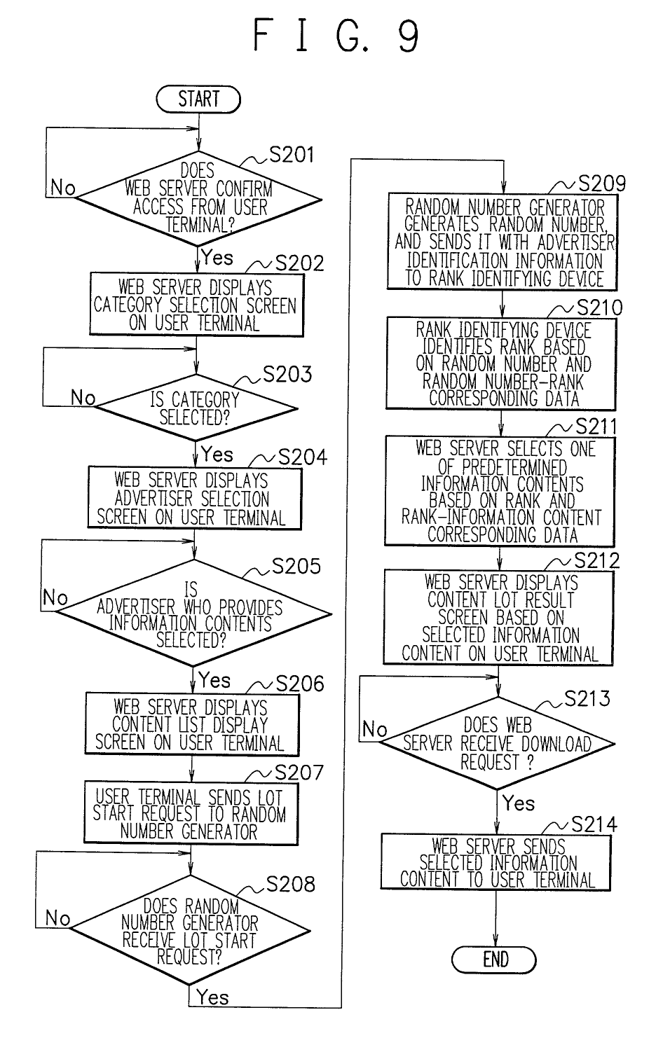

FIG. 9 is a flowchart showing operation of the banner advertising system according to the first embodiment of the present invention. In the following, an explanation will be given of the operation of the banner advertising system according to this embodiment in line with the flowchart in FIG. 9 referring to FIGS. 1 and 3 through 8.

First, the Web server 2 confirms whether or not the user terminal 1 accesses a prize Web site on the Web server 2 (Step S201). When the Web server 2 cannot confirm the access from the user terminal 1 (No in Step S201), Step S201 is repeated.

On the other hand, when confirming the access from the user terminal 1 (Yes in Step S201), the Web server 2 displays the category selection screen 40 on the screen of the user terminal 1 (Step S202).

After the category selection screen 40 was displayed, the Web server 2 determines whether or not the user terminal 1 has selected a category (Step S203). When the Web server 2 determines that the user terminal 1 has not selected a category (No in Step S203), Step S203 is repeated.

On the other hand, when determining that the user terminal 1 has selected a category (Yes in Step S203), the Web server 2 displays the banner advertisement selection screen (advertiser selection screen) 41 including a plurality of banner advertisements (advertisers) relative to the selected category on the screen of the user terminal 1 (Step S204).

After the banner advertisement selection screen 41 was displayed, the Web server 2 determines whether or not the user terminal 1 has selected any one of the banner advertisements displayed on the banner advertisement selection screen 41 (Step S205). When the Web server 2 determines that the user terminal 1 has not selected a banner advertisement (No in Step S205), Step S205 is repeated.

On the other hand, when determining that the user terminal 1 has selected any one of the advertisements (Yes in Step S205), the Web server 2 displays the content list display screen 42 including a list of contents provided by the advertiser of the selected banner advertisement on the screen of the user terminal 1 (Step S206).

After the content list display screen 42 was displayed, the user clicks the lot start button on the content list display screen 42, and the user terminal 1 sends the lot start request to the random number generator 3 through the Web server 2 (Step S207). Incidentally, the lot start request includes advertiser identification information used for identifying the advertiser of the banner advertisement clicked by the user.

The random number generator 3 confirms whether or not received the lot start request from the use terminal 1 (Step S208). When the random number generator 3 cannot confirm the receipt of the lot start request (No in Step S208), Step S208 is repeated.

On the other hand, when confirming the receipt of the lot start request (Yes in Step S208), the random number generator 3 generates a random number (random number information), and adds the advertiser identification information to the generated random number information. Subsequently, the generator 3 sends the random number information with the advertiser identification information to the rank identifying device 4 (Step S209).

The rank identifying device 4 receives the random number information with the advertiser identification information. Incidentally, the rank identifying device 4 stores random number—rank corresponding data with respect to each advertiser. The device 4 extracts the random number—rank corresponding data of the advertiser selected by the user terminal 1 on the basis of the received advertiser identification information. Subsequently, the device 4 identifies the rank on the basis of the received random number information and the extracted random number—rank corresponding data (Step S210). The device 4 adds the advertiser identification information to the identified rank information. Subsequently, the device 4 sends the rank information with the advertiser identification information to the Web server 2.

The Web server 2 receives the rank information with the advertiser identification information. Incidentally, the Web server 2 stores rank—information content corresponding data with respect to each advertiser. The Web server 2 extracts the rank—information content corresponding data of the advertiser selected by the user terminal 1 on the basis of the received advertiser identification information. Subsequently, the Web server 2 selects one of the information contents stored therein on the basis of the received rank information and the extracted rank—information content corresponding data (Step S211).

The Web server 2 displays the content lot result screen 43 based on the selected information content on the screen of the user terminal 1 (Step S212).

After the content lot result screen 43 was displayed, the Web server 2 confirms whether or not received the download request for the selected information content from the use terminal 1 (Step S213). When the Web server 2 cannot confirm the receipt of the download request (No in Step S213). Step S213 is repeated.

On the other hand, when confirming the receipt of the download request (Yes in Step S213), the Web server 2 sends the selected information content to the user terminal 1 (Step S214). After the information content was transmitted, the processing of the banner advertising system is finished.

As explained hereinbefore, when the information contents provided by a music company are music, etc. by singers belonging to the music company, it becomes possible to utilize the information contents as advertising media. Moreover, by displaying the advertising message 93, etc. on the display screen of the user terminal 1, the advertising effects can be raised.

According to this embodiment, the Web server 2 randomly selects an information content including factors of advertising, and sends the selected information content to the user terminal 1. The selected information content may or may not be the one desired by a user. Thereby, when the selected information content is not the desired one, the user will click the lot start button more than once until the desired information content is displayed on (transmitted to) the user terminal 1. Consequently, the advertiser can get users to repeatedly browse information contents provided by the advertiser. Moreover, advertising information such as the advertising message is displayed on the prize Web pages. Thereby, it becomes possible to achieve higher advertising effects by the information contents and the advertising messages.

In the following, an explanation will be given of a configuration of a banner advertising system according to the second embodiment of the present invention.

The configuration of the banner advertising system according to this embodiment is the same as that according to the first embodiment shown in FIG. 1 unless special mention is made.

The Web server 2 in this embodiment stores a plurality of advertising contents and gift contents of various kinds. The advertising contents are contents provided by advertisers and each including an advertisement(s) that the advertiser desires to push forward. The gift contents are contents each having information about a gift provided by an advertiser. By transmitting a gift content to the user terminal 1 and displaying the gift content on the display screen of the user terminal 1, the user qualifies for the gift indicated in the gift content. Incidentally, the advertising contents and the gift contents may be represented by character information, audio information (including voice, sound, and/or music information), static images, moving images, and/or the like. Incidentally, the Web server 2 stores prize Web pages for providing the advertising contents and the gift contents in response to a request from the user terminal 1.

Further, a “rank” serving as information for identifying a gift content is added to the respective gift contents of various kinds stored in the Web server 2. A gift content is selected on the basis of random number—rank corresponding data stored in the rank identifying device 4 and rank—gift content corresponding data stored in the Web server 2 in the same manner as the information contents in the first embodiment.

When receiving the lot start request (acquisition request) from the user terminal 1, the Web server 2 transmits an advertising content stored therein to the user terminal 1 to display an advertisement display screen 53 on the display screen of the user terminal 1. Concurrently with the transmission of the advertising content to the user terminal 1, the Web server 2 starts timekeeping. The Web server 2 selects one of the gift contents of various kinds stored therein on the basis of the rank information sent from the rank identifying device 4 and the rank—gift content corresponding data stored therein. After a predetermined time has passed, the Web server 2 transmits the selected gift content to the user terminal 1. Incidentally, the Web server 2 may select “nothing” regarding the user as drawing a losing ticket.

The rank identifying device 4 identifies a rank on the basis of random number information sent from the random number generator 3 and the random number—rank corresponding data stored therein. Namely, the rank identifying device 4 in this embodiment converts a random number to a predetermined value (rank) corresponding to each gift content on the basis of the random number—rank corresponding data. The identified rank information is sent to the Web server 2.

Incidentally, as described in the first embodiment, it is possible to set an arbitrary value for the respective random numbers and ranks. Moreover, the advertising contents and the gifts contents both provided by the advertisers can also be changed. Further, the random number—rank and rank—gift contents corresponding data can be arbitrarily set.

In the following, an explanation will be given of operation of the banner advertising system according to the second embodiment of the present invention.

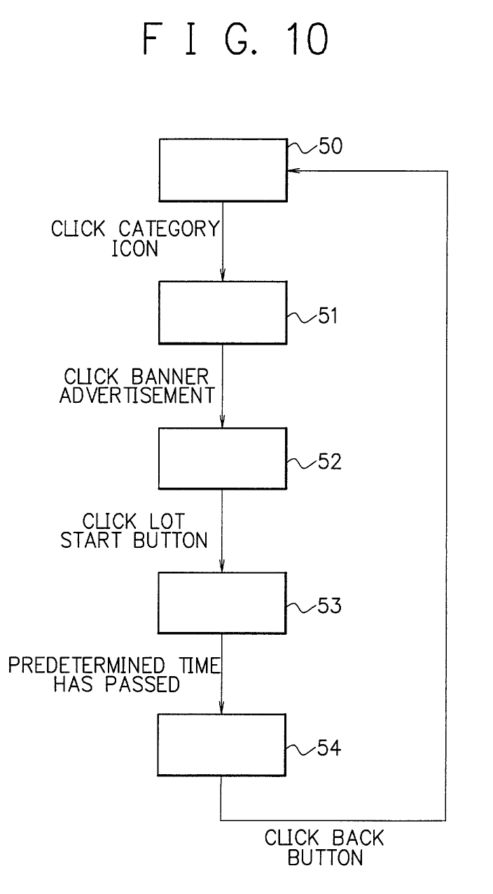

FIG. 10 is a diagram showing transition of display screens of prize Web pages used in the banner advertising system according to the second embodiment of the present invention. In this embodiment, at least a category selection screen 50, a banner advertisement selection screen 51, a gift list display screen 52, an advertisement display screen 53, and a gift lot result screen 54 are displayed on the screen of the user terminal 1 as the prize Web pages.

The category selection screen 50 in this embodiment is the same as the category selection screen 40 used in the first embodiment unless special mention is made. It is assumed that the category selection screen 50 has the same screen configuration as the screen 40 shown in FIG. 4, and thereby, the explanation is abbreviated. Incidentally, after a user has clicked one of the category icons 61 through 68 as with the first embodiment, the display screen of the user terminal 1 changes to the banner advertisement selection screen 51 corresponding to the clicked category icon.

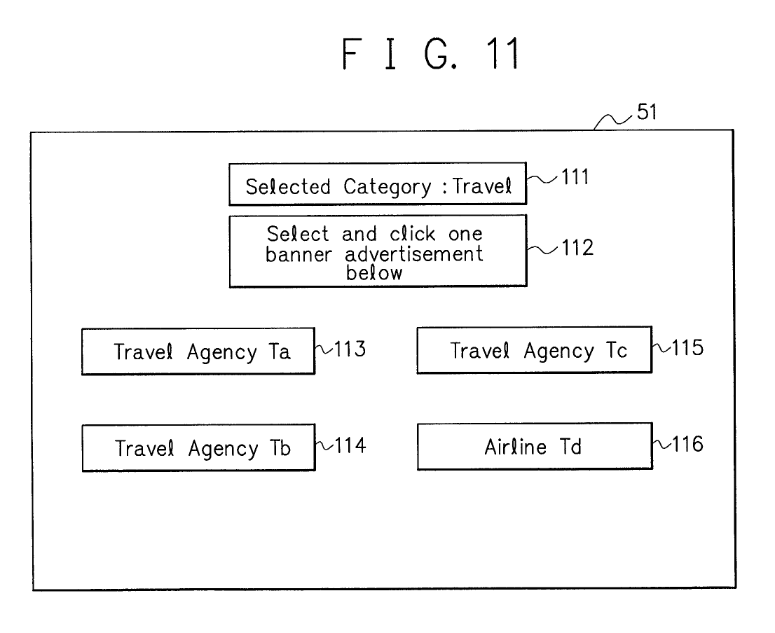

FIG. 11 is a diagram showing a screen configuration of the banner advertisement selection screen 51 used in the banner advertising system according to the second embodiment of the present invention. The banner advertisement selection screen 51 comprises at least a selected category display 111, a banner advertisement selection message 112, and banner advertisements 113 through 116. Incidentally, FIG. 11 shows an example of the banner advertisement selection screen 51 when the category icon 62 “Travel” is selected in the category selection screen 50.

The name of the category “Travel” selected in the category selection screen 50 is displayed in the selected category display 111. Names of advertisers relative to the category “Travel” such as “Travel Agency Ta”, “Travel Agency Tb”, “Travel Agency Tc”, and “Airline Td” are displayed in the respective banner advertisements 113 through 116. The user selects and clicks any one of the banner advertisements 113 through 116 using the user terminal 1 according to the instruction “Select and click one banner advertisement below.” displayed as the banner advertisement selection message 112. When a banner advertisement is selected and clicked, the display screen of the user terminal 1 changes to the gift list display screen 52 relevant to the advertiser of the clicked banner advertisement.

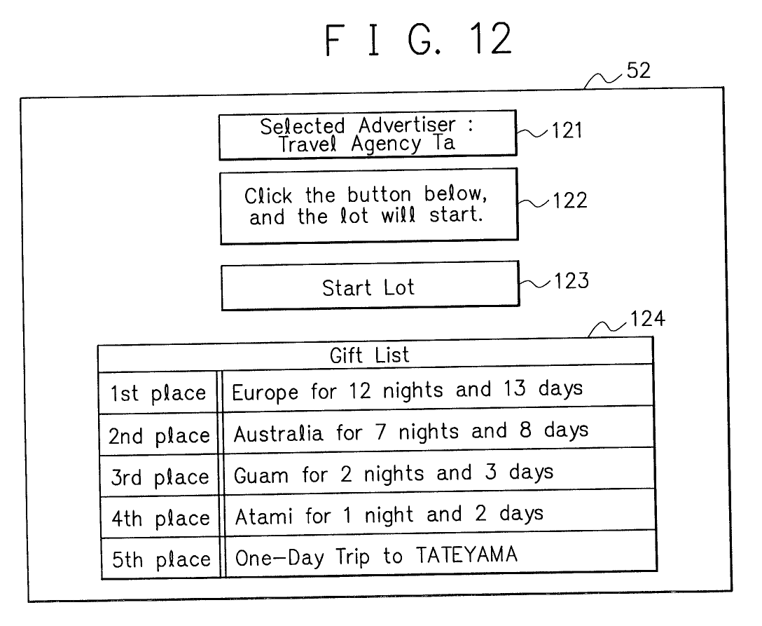

FIG. 12 is a diagram showing a screen configuration of the gift list display screen 52 used in the banner advertising system according to the second embodiment of the present invention. The gift list display screen 52 comprises at least a selected advertiser display 121, a lot start message 122, a lot start button 123, and a gift list 124. Incidentally, FIG. 12 shows an example of the gift list display screen 52 when the banner advertisement 113 “Travel Agency Ta” is selected in the banner advertisement selection screen 51.

The name of the advertiser “Travel Agency Ta” of the banner advertisement selected in the banner advertisement selection screen 51 is displayed in the selected advertiser display 121. There is displayed in the gift list 124 available gifts provided by the advertiser such as “1st place: Europe for 12 nights and 13 days”, “2nd place: Australia for 7 nights and 8 days”, “3rd place: Guam for 2 nights and 3 days”, “4th place: Atami for 1 night and 2 days”, and “5th place: One—Day Trip to Tateyama”. The user clicks the lot start button 123 using the user terminal 1 according to the instruction “Click the button below, and the lot will start.” displayed in the lot start message 122. When the lot start button 123 is clicked, the lot starts, and the display screen of the user terminal 1 changes to the advertisement display screen 53.

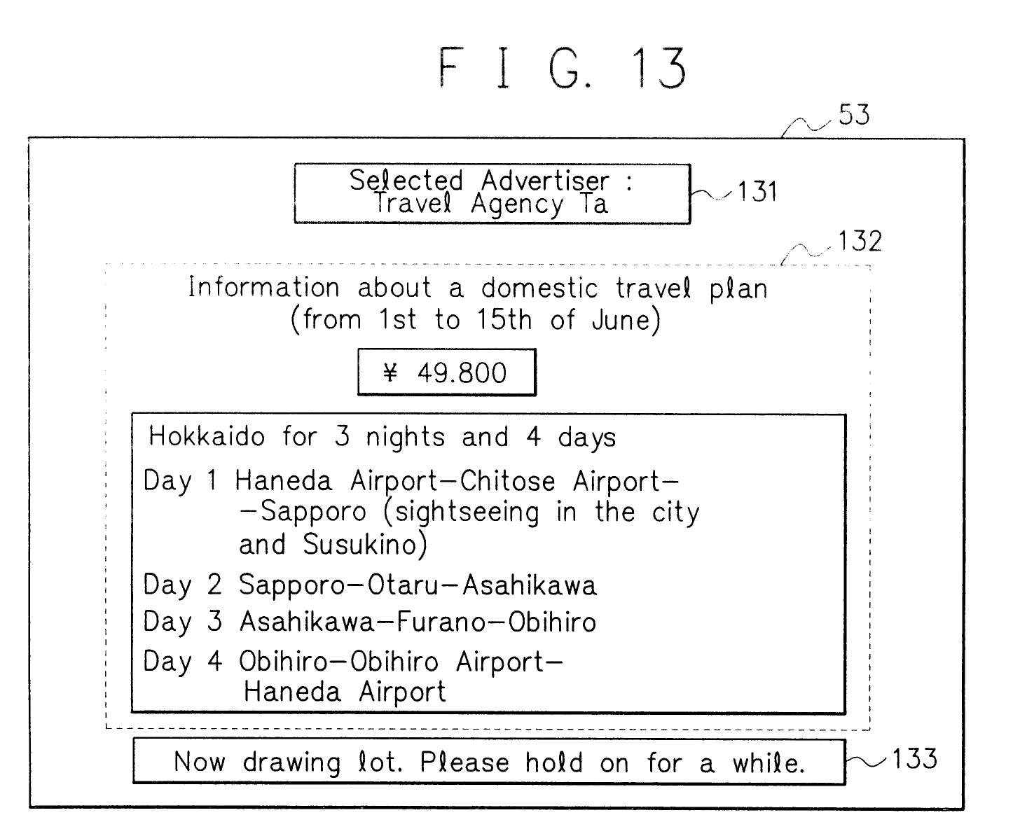

FIG. 13 is a diagram showing a screen configuration of the advertisement display screen 53 used in the banner advertising system according to the second embodiment of the present invention. The advertisement display screen 53 comprises at least a selected advertiser display 131, an advertising message 132, and an in—lotting message 133. Incidentally, it becomes possible to display the advertisement display screen 53 on the screen of the user terminal 1 when an advertising content including the advertising message 132, which is provided by the advertiser, is sent from the Web server 2 to the user terminal 1. The subject matter of the advertising message 132 set by the advertiser may or may not be related to a gift(s) provided by the advertiser.

The name of the advertiser “Travel Agency Ta” of the banner advertisement selected in the banner advertisement selection screen 51 is displayed in the selected advertiser display 131. An advertising information such as “Information about a domestic travel plan (from the 1st to 15th of June) . . .” is displayed as the advertising message 132 as shown in FIG. 13. A message such as “Now drawing lot. Please hold on for a while.” is displayed as the in—lotting message 133. Incidentally, the advertising message may not be represented by character as shown in FIG. 13. For example, a static image of a destination of a Travel, a moving image, voice information and/or the like can be employed for the advertising message 132.

The advertisement display screen 53 is displayed on the screen of the user terminal 1 for a predetermined time. The display time of the advertisement display screen 53 is arbitrarily set in advance by the Web server 2. After the predetermined time has passed from the display of the advertisement display screen 53, the display screen of the user terminal 1 changes to the gift lot result screen 54.

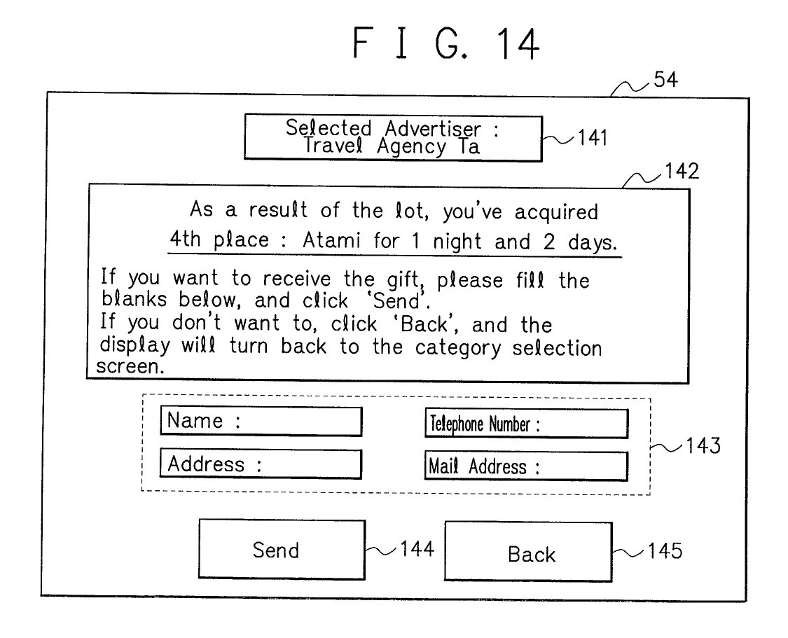

FIG. 14 is a diagram showing a screen configuration of the gift lot result screen 54 used in the banner advertising system according to the second embodiment of the present invention. The gift lot result screen 54 comprises at least a selected advertiser display 141, a lot result message 142, a user data registration column 143, a send button 144, and a back button 145. Incidentally, it becomes possible to display the gift lot result screen 54 on the screen of the user terminal 1 when a gift content including the lot result message 142 is sent from the Web server 2 to the user terminal 1. FIG. 14 shows an example of the gift lot result screen 54 when the user is given a right to acquire the gift “4th place: Atami for 1 night and 2 days” selected from the gift list 124 shown in FIG. 12.

The name of the advertiser “Travel Agency Ta” of the banner advertisement selected in the banner advertisement selection screen 51 is displayed in the selected advertiser display 141. There is displayed as the lot result message 142 a message that the user was given a right to acquire the gift “4th place: Atami for 1 night and 2 days”. Moreover in the message 142, there is indicated an instruction to input predetermined necessary information in the user data registration column 143 and click the send button 144 when the user is willing to acquire the gift, and otherwise, to click the back button 145 when the user is not willing to acquire the gift.

When the user inputs his or her personal data in the user data registration column 143 and clicks the send button 144, the personal data is transmitted to and registered in the Web server 2. After the registration has been finished, the procedure for handing over the gift to the user is performed. On the other hand, when the user clicks the back button 145, the display screen of the use terminal 1 changes again to the category selection screen 50.

While in the above explanation the plural advertisers are employed, a single advertiser may be employed. In this case, the category selection screen 50 and the banner advertisement selection screen 51 do not have to be displayed on the screen of the user terminal 1. Moreover in this case, the Web server 2 may display the gift list display screen 52 on the screen of the user terminal 1 after having confirmed the access from the user terminal 1. The Web server 2 may display another kind of screen thereon.

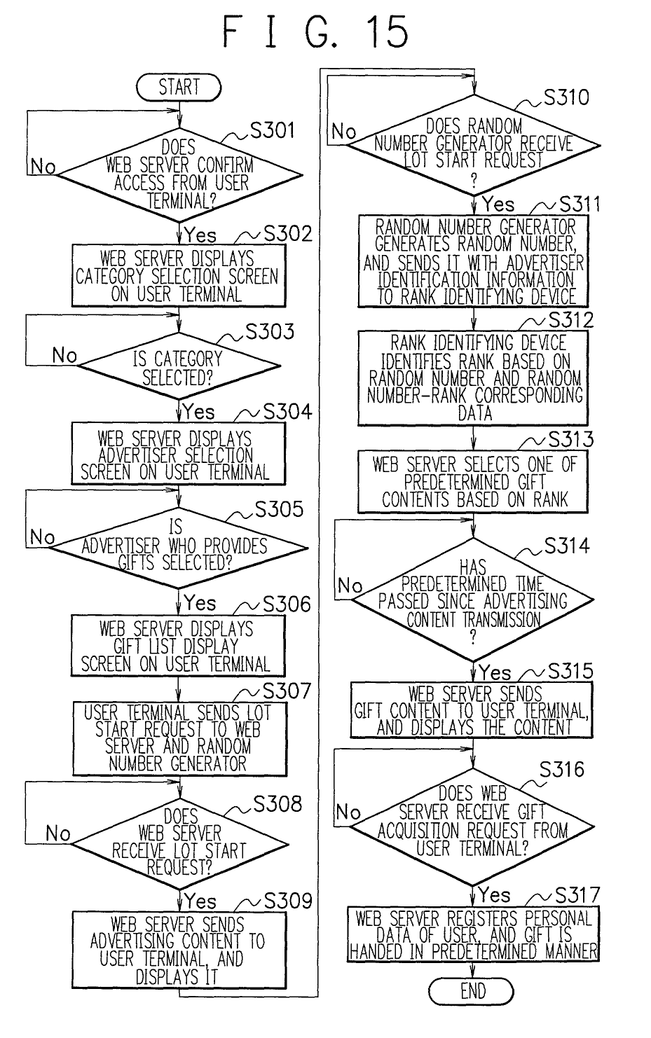

In the following, an explanation will be given of operation of the banner advertising system according to the second embodiment of the present invention in line with the flowchart in FIG. 15 referring to FIGS. 1 and 10 through 14.

First, the Web server 2 confirms whether or not the user terminal 1 accesses a prize Web site on the Web server 2 (Step S301). When the Web server 2 cannot confirm the access from the user terminal 1 (No in Step S301), Step S301 is repeated.

On the other hand, when confirming the access from the user terminal 1 (Yes in Step S301), the Web server 2 displays the category selection screen 50 on the screen of the user terminal 1 (Step S302).

After the category selection screen 50 was displayed, the Web server 2 determines whether or not the user terminal 1 has selected a category (Step S303). When the Web server 2 determines that the user terminal 1 has not selected a category (No in Step S303), Step S303 is repeated.

On the other hand, when determining that the user terminal 1 has selected a category (Yes in Step S303), the Web server 2 displays the banner advertisement selection screen (advertiser selection screen) 51 including a plurality of banner advertisements relative to the selected category on the screen of the user terminal 1 (Step S304).

After the banner advertisement selection screen 51 was displayed, the Web server 2 determines whether or not the user terminal 1 has selected any one of the banner advertisements displayed on the banner advertisement selection screen 51 (Step S305). When the Web server 2 determines that the user terminal 1 has not selected an advertisement (No in Step S305), Step S305 is repeated

When determining that the user terminal 1 has selected any one of the banner advertisements (Yes in Step S305), the Web server 2 displays the gift list display screen 52 including the gifts provided by the selected advertiser on the screen of the user terminal 1 (Step S306).

After the gift list display screen 52 was displayed, the user clicks the lot start button on the gift list display screen 52, and the user terminal 1 sends the lot start request to the Web server 2. The lot start request from the user terminal 1 is transmitted to the random number generator 3 through the Web server 2 (Step S307). Incidentally, the lot start request includes advertiser identification information.

Subsequently, the Web server 2 confirms whether or not received the lot start request from the use terminal 1 (Step S308). When the Web server 2 cannot confirm the receipt of the lot star request (No in Step S308), Step S308 is repeated.

On the other hand, when confirming the receipt of the lot start request (Yes in Step S308), the Web server 2 transmits the advertising content to the user terminal 1, thus enabling the advertisement display screen 53 to be displayed on the screen of the user terminal 1 (Step S309).

The random number generator 3 confirms whether or not received the lot start request from the user terminal 1 via the Web server 2 (Step S310). When the random number generator 3 cannot confirm the receipt of the lot start request (No in Step S310), Step S310 is repeated.

On the other hand, when confirming the receipt of the lot start request (Yes in Step S310), the random number generator 3 generates a random number, and adds the advertiser identification information to the generated random number information. Subsequently, the generator 3 sends the random number information with the advertiser identification information to the rank identifying device 4 (Step S311).

The rank identifying device 4 receives the random number information with the advertiser identification information. Incidentally, the rank identifying device 4 stores random number—rank corresponding data with respect to each advertiser. The device 4 extracts the random number—rank corresponding data of the advertiser selected by the user terminal 1 on the basis of the received advertiser identification information. Subsequently, the device 4 identifies the rank on the basis of the received random number information and the extracted random number—rank corresponding data (Step S312). The device 4 adds the advertiser identification information to the identified rank information. Subsequently, the device 4 sends the rank information with the advertiser identification information to the Web server 2.

The Web server 2 receives the rank information with the advertiser identification information. Incidentally, the Web server 2 stores rank—gift content corresponding data with respect to each advertiser. The Web server 2 extracts the rank—gift content corresponding data of the advertiser selected by the user terminal 1 on the basis of the received advertiser identification information. Subsequently, the Web server 2 selects one of the gift contents stored in the Web server 2 on the basis of the received rank information and the extracted rank—gift content corresponding data (Step S313).

The Web server 2 determines whether or not a predetermined time has passed after the transmission of the advertising content to the user terminal 1 (Step S314). When the Web server 2 determines that the predetermined time has not passed (No in Step S314), Step S314 is repeated.

On the other hand, when determining that the predetermined time has passed (Yes in Step S314), the Web server 2 transmits the selected gift content to the user terminal 1, thus enabling the gift lot result screen 54 to be displayed on the screen of the user terminal 1 (Step S315).

After the gift lot result screen 54 was displayed, the user terminal 1 sends a gift acquisition request to the Web server 2 when desiring to acquire the gift indicated in the lot result message 142 in the gift lot result screen 54. Incidentally, the gift acquisition request includes the personal data of the user of the user terminal 1.

Subsequently, the Web server 2 confirms whether or not received the gift acquisition request from the use terminal 1 (Step S316). When the Web server 2 cannot confirm the receipt of the gift acquisition request (No in Step S316), Step S316 is repeated.

On the other hand, when confirming the receipt of the gift acquisition request (Yes in Step S316), the Web server 2 registers the personal data included in the received gift acquisition request, and the gift is handed over to the user in a predetermined manner (Step S317). After the handing over of the gift has been finished, the banner advertising system finishes its operation.

According to this embodiment, the Web server 2 randomly selects one gift content and sends the selected gift content to the user terminal 1. The selected gift content may or may not be the one desired by a user. Thereby, when the selected gift content is not the desired one, the user will click the lot start button more than once until the desired gift content is displayed on (transmitted to) the user terminal 1. While the lots are drawn (before the gift lot result screen 54 is displayed on the screen of the user terminal 1), the advertisement display screen 53 including an advertising content(s) is always displayed on the screen of the user terminal 1 for a predetermined time. The user browses the advertisement display screen 53 in expectation of a positive result of the lot, thus enabling higher advertising effects by the advertising content.

Moreover, the number of the clicks of the lot start button may be counted so that the advertisers can check the users' preference for the gifts, thus enabling the advertisers to change the gifts for the more attractive ones to get users to browse the advertising contents more frequently.

Incidentally, the Web server 2 may store plural kinds of advertising contents provided by the respective advertisers. In this case, the Web server 2 selects and sends at least one advertising content to the user terminal 1 according to the season when the lot start request is transmitted from the user terminal 1, personal data of the user of the user terminal 1, or the like.

Moreover, when the plural kinds of advertising contents are stored in the Web server 2, an advertising content is randomly selected and transmitted to the user terminal by the functions of the Web server 2, the random number generator 3, and the rank identifying device 4 as with the case of dealing with the information content in the first embodiment and the gift content in the second embodiment.

Further, while the banner advertisements used in the first and second embodiments display the names of the advertisers, it is also possible to include advertising information therein as with general banner advertisements. Incidentally, the banner advertisements are not limited to static images; namely, the banner advertisements may include moving images, audio information (including music, voice, sound information, etc.), and the like.

Furthermore, while in the first and second embodiments, the information contents, the advertising content(s), and the gift contents are stored in the Web server 2, those contents may be stored in a predetermine database connected to the Web server 2 via a predetermined network. For example, the information contents, the advertising content(s), and the gift contents may be stored in a server connected via the Internet 5 and managed by an advertiser.

Additionally, the user terminal 1 transmits various requests to the Web server 2 and the random number generator 3, receives various Web pages and contents transmitted from the Web server 2, and displays them on the screen of its own. The Web server 2 receives the requests from the user terminal 1, and transmits the Web pages and contents to the user terminal 1 to enable the Web pages and contents to be displayed on the screen of the user terminal 1. The random number generator 3 receives the lot start request from the user terminal 1 and generates a random number. The rank identifying device 4 identifies a rank on the basis of the random number information generated by the random number generator 3 and the random number—rank corresponding data. Further, the Web server 2 selects a content on the basis of the rank information identified by the rank identifying device 4 and the rank—content (information content or gift content) corresponding data. Each process is executed by the programs included in the user terminal 1, the Web server 2, the random number generator 3 and the rank identifying device 4, respectively. The respective programs may be stored in a recoding medium(s) such as an optical disk, a magnetic disk, or the like so that the programs can be downloaded therefrom.

It is further understood by those skilled in the art that the foregoing descriptions are preferred embodiments of the present invention and that various changes and modifications may be made in the invention without departing from the spirit and scope thereof.

As set forth hereinbefore, according to the present invention, when receiving an acquisition request for information including advertisements from the user terminal, the Web server randomly selects a piece of information from plural kinds of information stored therein and transmits the information to the user terminal. Thereby, the user terminal transmits the acquisition request numerous times until the user can acquire his or her desired information, thus enabling higher advertising effects by the information including advertisements.

Further, according to the present invention, when the user terminal desires to acquire information provided by a predetermined advertiser and transmits the acquisition request to the Web server, the Web server displays advertising information relevant to the advertiser on the screen of the user terminal for a predetermined time before transmitting a piece of information randomly selected from plural kinds of information stored therein. Thereby, the user browses the advertising information displayed at present in expectation of information to be displayed after a predetermined time, thus enabling higher advertising effects by the advertising information.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A banner advertising system comprising:
a Web server for storing plural kinds of information including advertisements; and
a user terminal connected to the Web server through a predetermined network; wherein
the Web server transmits information randomly extracted from the plural kinds of information including advertisements to the user terminal when receiving an acquisition request for information from the user terminal.

2. A banner advertising system comprising;
a user terminal connected to a predetermined network for transmitting an acquisition request for information through the predetermined network;
a Web server connected to the predetermined network for receiving the acquisition request for information from the user terminal through the predetermined network;
a random number generator connected to the Web server for generating a random number in response to the acquisition request for information received via the Web server; and
a rank identifying device connected to the Web server and the random number generator for converting the random number generated by the random number generator to predetermined data; wherein
the Web server extracts any one of plural kinds of information stored in the Web server on the basis of the predetermined data converted by the rank identifying device, and transmits the extracted information to the user terminal.

3. A banner advertising system comprising:
a user terminal connected to a predetermined network for transmitting an acquisition request for information provided by an advertiser through the predetermined network;
a Web server connected to the predetermined network for transmitting advertising information including at least an advertisement to the user terminal and displaying the advertising information on the user terminal when receiving the acquisition request for the provided information from the user terminal through the predetermined network;
a random number generator connected to the Web server for generating a random number in response to the acquisition request for the provided information received via the Web server; and
a rank identifying device connected to the Web server and the random number generator for converting the random number generated by the random number generator to predetermined data; wherein
the Web server extracts any one of the provided information of plural kinds stored in the Web server on the basis of the predetermined data converted by the rank identifying device, and transmits the extracted provided information to the user terminal.

4. The banner advertising system as claimed in claim 3, wherein the Web server measures time since the Web server transmitted the advertising information to the user terminal, and transmits the extracted provided information to the user terminal when the measured time exceeds a predetermined time.

5. A banner advertising system comprising:
a Web server connected to a user terminal through a predetermined network for receiving an acquisition request for information from the user terminal;
a random number generator connected to the Web server for generating a random number in response to the acquisition request for information received via the Web server; and
a rank identifying device connected to the Web server and the random number generator for converting the random number generated by the random number generator to predetermined data; wherein
the Web server extracts any one of information of plural kinds stored in the Web server on the basis of the predetermined data converted by the rank identifying device, and transmits the extracted information to the user terminal.

6. A banner advertising method using a Web server storing plural kinds of information including advertisements and a user terminal connected to the Web server through a predetermined network, wherein
the Web server transmits information randomly extracted from the plural kinds of information including advertisements to the user terminal when receiving an acquisition request for information from the user terminal.

7. A banner advertising method, when a Web server receives an acquisition request for information from a user terminal through a predetermined network, comprising the steps of:
generating a random number;
converting the generated random number to predetermined data;
extracting any one of information of plural kinds on the basis of the converted predetermined data; and
transmitting the extracted information to the user terminal.

8. A banner advertising method, when a Web server receives an acquisition request for information provided by an advertiser from a user terminal through a predetermined network, comprising the steps of:
transmitting advertising information including at least an advertisement to the user terminal;
displaying the advertising information on the user terminal;
generating a random number;
converting the generated random number to predetermined data;
extracting any one of the provided information of plural kinds on the basis of the converted predetermined data; and
transmitting the extracted provided information to the user terminal.

9. The banner advertising method as claimed in claim 8, wherein the Web server measures time since the Web server transmitted the advertising information to the user terminal, and transmits the extracted provided information to the user terminal when the measured time exceeds a predetermined time.

10. A banner advertising program for executing processes by a Web server storing plural kinds of information including advertisements, and a user terminal connected to the Web server through a predetermined network, wherein
the Web server transmits information randomly extracted from the plural kinds of information including advertisements to the user terminal when receiving an acquisition request for information from the user terminal.

11. A banner advertising program for executing:
a process, by a Web server, of receiving an acquisition request for information from a user terminal connected to the Web server through a predetermined network;
a process, by a random number generator connected to the Web server, of generating a random number in response to the acquisition request for information received via the Web server;
a process, by a rank identifying device connected to the Web server and the random number generator, of converting the random number generated by the random number generator to predetermined data; and
a process, by the Web server, of extracting any one of information of plural kinds stored in the Web server on the basis of the predetermined data converted by the rank identifying device and transmitting the extracted information to the user terminal.

12. A banner advertising program for executing:
a process, by a Web server, of transmitting advertising information including at least an advertisement to a user terminal and displaying the advertising information on the user terminal when receiving an acquisition request for information provided by an advertiser from the user terminal connected through a predetermined network;
a process, by a random umber generator connected to the Web server, of generating a random number in response to the acquisition request for the provided information received via the Web server;
a process, by a rank identifying device connected to the Web server and the random number generator, of converting the random number generated by the random number generator to predetermined data; and
a process, by the Web server, of extracting any one of the provided information of plural kinds stored in the Web server on the basis of the predetermined data converted by the rank identifying device, and transmitting the extracted provided information to the user terminal.

13. The banner advertising program as claimed in claim 12 executing a process, by the Web server, of measuring time since the Web server transmitted the advertising information to the user terminal, and transmitting the extracted provided information to the user terminal when the measured time exceeds a predetermined time.
